(19) United States
(12) Patent Application Publication
(10) Pub. No.: US 2009/0150333 A1
(43) Pub. Date: Jun. 11, 2009

(54) IN-CONTEXT COLLABORATION TOOL FOR RESOURCE MANAGEMENT SYSTEMS

(75) Inventors: Salvatore D'Alo', Rome (IT); Arcangelo Di Balsamo, Aprilia (LT) (IT); Rosario Gangemi, Lavinio (IT); Giovanni Lanfranchi, Piacenza (IT); Scot MacLellan, Rome (IT); Luigi Pichetti, Rome (IT)

Correspondence Address: IBM CORP. (AUSTIN), C/O NELSON AND NELSON, 2984 E. EVERGREEN AVE., SALT LAKE CITY, UT, 84109, US

(73) Assignee: INTERNATIONAL BUSINESS MACHINES CORPORATION, Armonk, NY (US)

(21) Appl. No.: 12/264,254

(22) Filed: Nov. 4, 2008

(30) Foreign Application Priority Data
Dec. 10, 2007 (EP) EP07122707

(51) Int. Cl. G06F 17/30

(52) U.S. Cl. 707/1; 707/E17.001

(57) ABSTRACT

A method for managing resources in a resource management system in accordance with certain embodiments may include providing a retrieval statement for retrieving management information relating to a set of selected resources. The management information may be retrieved according to the retrieval statement. Context information relating to one or more resources of the set may be retrieved according to the corresponding management information. One or more requests for additional information relating to the resource may be generated according to the context information. The requests for additional information may then be submitted to an information source.

### BACKGROUND OF THE INVENTION

### Description of the Related Art

Resource management systems are widely used to manage a number of logical and/or physical resources. A typical scenario is that of a license management application, which may be used to verify compliance of software products that are installed on a data processing system with licenses that have been acquired for their usage.

One example of a commercial license management application is the “IBM Tivoli License Compliance Manager (ITLCM)” by IBM Corporation. Generally, resource management systems implement operational dashboards, which provide a visual representation of a current status of the resources to be managed. This representation is based on the metaphor of instrument panels in cars. Particularly, the dashboards offer intuitive interfaces that facilitate access to the resource management systems not only by technical people, but also by business people without specific technical expertise.

Nevertheless, the corresponding resource management process remains a largely manual task. For example, in the above-mentioned license management scenario, whenever a system administrator wishes to verify compliance of the system with available licenses, a report may be generated that lists all the non-compliant computers of the system having non-compliant software products installed thereon. For each non-compliant computer, the system administrator may attempt to ascertain the cause of the problem. Such causes may include, for example, a software product installed by accident, a computer incorrectly assigned, a license to be acquired, and the like.

To this end, the system administrator may collect additional information such as details about the non-compliant computer, such as its location, details about the non-compliant software product, such as its installation date, and the like. It may also be necessary to contact persons that can help solve the problem by providing further data. For example, it may be useful to contact an owner of the non-compliant computer, his/her manager, a support center of the non-compliant software product, and the like.

In this context, collaborative applications may be implemented to facilitate interaction among people to achieve a common goal. Such collaborative applications may include e-mail, instant messages, electronic conferences, and the like. The system administrator may submit a request to the owner of the non-compliant computer for explanations. The system administrator may also submit a request to the support center of the non-compliant software product for details regarding specific license conditions that may apply.

In any case, the system administrator may be required to perform a detailed investigation. During the course of this investigation, the system administrator must identify persons able to provide relevant information. As such persons may change according to contingent conditions, it may become necessary to prepare and submit several requests for information to various people. The system administrator must decide how to contact these people, and determine which data to provide to facilitate the persons' ability to provide correct information.

### SUMMARY OF THE INVENTION

Embodiments of the invention have been developed to provide in-context collaboration tool for resource management systems.

A method for managing resources in a resource management system in accordance with certain embodiments may include providing a retrieval statement for retrieving management information relating to a set of selected resources. The management information may be retrieved according to the retrieval statement. Context information relating to one or more resources of the set may be retrieved based on the management information, and one or more requests for additional information relating to the resource may be generated according to the context information. The requests for additional information may then be submitted to an information source.

A corresponding system and computer program product implementing the above-stated method are also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 depicts a data processing system in accordance with an embodiment of the invention;

FIG. 2 illustrates exemplary applications for an in-context collaboration tool in accordance with an embodiment of the invention;

FIG. 3 illustrates further exemplary applications for an in-context collaboration tool in accordance with an embodiment of the invention;

FIG. 4 illustrates still further exemplary applications for an in-context collaboration tool in accordance with an embodiment of the invention; and

FIG. 5 is a collaboration diagram representing the roles of different software components that may be used to implement an embodiment of the invention.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

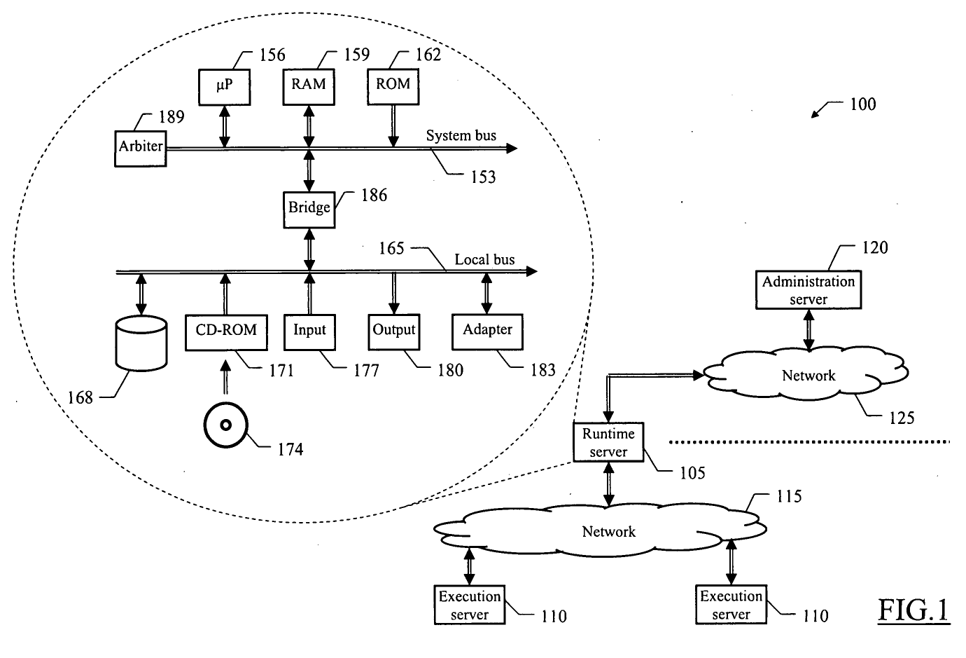

With reference to FIG. 1, a data processing system 100 with distributed architecture may include one or more independent organizations, which may be completely separate and distinct from each other. Within the organization, different divisions may be defined. Each division may be controlled by a runtime server 105, to which a set of execution servers 110 may be assigned. For this purpose, the runtime server 105 and the execution servers 110 of the division may communicate through a network 115, for example, a LAN. The different runtime servers 105 may report to a single administration server 120, which may implement a central control point of the whole organization. The runtime servers 105 and the administration server 120 may be connected to a different network 125, for example, a Virtual Private Network or VPN based on the Internet.

Particularly, the runtime server 105 of a generic division may be formed by several units connected in parallel to a system bus 153. More particularly, one or more microprocessors 156 may control operation of the runtime server 105, a RAM 159 may be directly used as a working memory by the microprocessors 156, and a ROM 162 may store basic code for a bootstrap of the runtime server 105.

Several peripheral units may be clustered around a local bus 165 by means of respective interfaces. Particularly, a mass memory may consist of one or more hard-disks 168 and drives 171 for reading DVD- or CD-ROMs 174. The runtime server 105 may further include input units 177, for example, a keyboard and a mouse, and output units 180, for example, a monitor and a printer. An adapter 183 may be used to connect the runtime server 105 to the network 115.

A bridge unit 186 may interface the system bus 153 with the local bus 165. Each microprocessor 156 and the bridge unit 186 may operate as master agents requesting access to the system bus 153 to transmit information. An arbiter 189 may manage the granting of access with mutual exclusion to the system bus 153.

In certain embodiments, the above-described structure may implement a resource management system for managing logical and/or physical resources. More specifically, the resource management system may be based on a license management application, such as the above-mentioned ITLCM, which may be used to manage licensed software products installed on the execution servers 110 of each division.

A resource management process may involve retrieval of management information, which lists resources that have been selected according to desired filtering criteria. In one example, the management information may include a non-compliance report generated on the runtime server 105 of the division. The non-compliance report may identify non-compliant execution servers 110 having one or more software products installed thereon without a corresponding license, for example.

The management information may then be analyzed to determine actions needed to manage the selected resources. For this purpose, it is generally necessary to retrieve additional information with respect to the selected resources. In the present example, the system administrator may analyze the non-compliance report to ascertain, for each non-compliant execution server 110, the cause of the problem and how to solve it. For example, a non-compliant software product installed by accident should be removed, a non-compliant execution server 110 assigned incorrectly should be reassigned, a missing license for a non-compliant software product should be acquired, and the like.

In one embodiment, context information may be retrieved for a specific selected resource, as described in more detail below. The context information may provide data to retrieve the corresponding additional information. The context information may include filtering criteria used to select the resource of interest, such as a site and a department of the non-complaint execution server 110, for example. The context information may further include data specifically collected for this purpose, such as data identifying an owner of the non-compliant execution server 110 and a support center of the corresponding non-complaint software product. In both cases, the context information may be retrieved by exploiting the content of the management information for the specific selected resource.

One or more requests may then be generated to retrieve the additional information for each selected resource, or group thereof. Such requests may be automatically populated with the corresponding context information. For example, the requests may consist of instant or e-mail messages, which include part of the context information of the non-compliant execution server 110. Such information may include the site, department, and/or owner of the non-compliant execution server 110.

The request may be submitted to one or more information sources able to return the desired additional information. For example, the message may be sent to the owner of the non-compliant execution server 110, and/or to the support center of the non-compliant software product.

In some embodiments, the context information may be retrieved automatically for each selected resource and used to generate and submit any request for the desired additional information. This may facilitate collaborative interaction between different information sources to secure the information, while minimizing dependency on the skills and acquaintances of the system administrator. In this manner, the resource management process may be simplified and performed with increased efficiency.

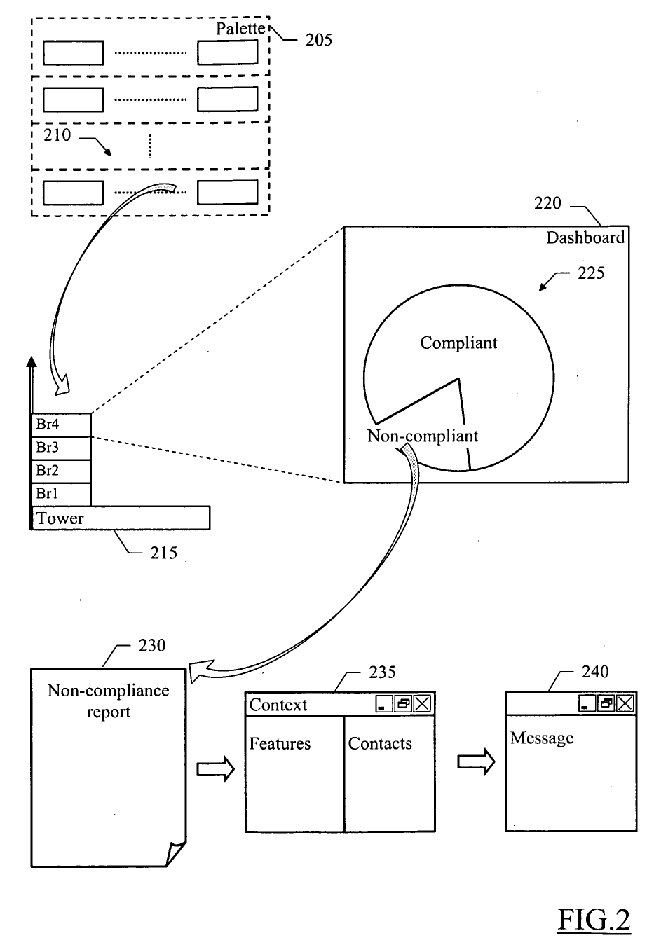

Referring now to FIG. 2, one embodiment of the invention may include a runtime server provided with a Graphical User Interface (GUI). In some embodiments, the GUI may configure the monitor display similar to a desktop where a frame defines a palette 205 for selecting different bricks 210. Each brick 210 may represent a basic block that may be used to construct a complex retrieval statement for the generation of the management information (i.e., the non-compliance report). For this purpose, each basic block may include retrieval instructions, which partially contribute to generating the management information. In one embodiment, for example, the retrieval instructions include the most common filtering criteria for the execution servers, such as their site and department.

In some embodiments, a system administrator may select a brick 210 in the palette 205 by moving it, for example, with a drag-and-drop operation, to a dedicated area of the desktop in the form of a tower 215. In the example shown in FIG. 2, the tower 215 includes four selected bricks 210, which are denoted with Br1, Br2, Br3 and Br4. In certain embodiments, the retrieval instructions may include one or more parameters to be assigned at runtime. When the corresponding brick 210 is selected, a pop-up window may be opened for assigning dynamic values to the corresponding parameters.

For example, brick Br1 may be defined for selecting all the execution servers of the division. Bricks Br2 and Br3 may be defined for filtering the result according to site and department, respectively. Brick Br4 may restrict the result to the execution servers that are not compliant.

Retrieval instructions of the selected bricks may be combined to generate a corresponding retrieval statement for generating the management information, such as a query for the non-compliance report. In one embodiment, the retrieval instructions of the first brick Br1 may be applied to a universal domain, the retrieval instructions of the next brick Br2 may be applied to a subset resulting from application of the retrieval instructions of the preceding brick Br1, and so on. The desktop may include another frame defining a dashboard 220 for outputting a global result of the retrieval statement corresponding to the selected bricks. The global result may show an overall view of the status of the system. The global result may be displayed in the dashboard 220, and may take any graphical form. For example, the global result may be displayed as a pie chart 225 as shown in FIG. 2. The pie chart 225 for the selected bricks may represent how the execution servers of the division (Br1) at a specific site (Br2) and in a specific department (Br3) split according to their compliance with the available licenses.

The system administrator may drill-down the pie-chart 225 to obtain a detailed result focusing on the management information relating to selected resources. For this purpose, the system administrator may select a slice of the pie chart 225. In response, a pop-up window defining a viewer 230 may be opened. The viewer 230 may list the management information for all the selected resources. In the present example, the viewer 230 may display a non-compliance report identifying all the non-compliant execution servers by a corresponding host name. In this way, the desired management information may be obtained in a very simple and intuitive manner.

In one embodiment of the invention, the system administrator may highlight each selected resource of interest in the viewer 230. For example, the system administrator may highlight a single selected resource (by double-clicking over its management information with the mouse), multiple selected resources (by maintaining the CTRL key during resource selection) or all of them together (by double-clicking on a caption bar of the viewer 230).

As a result, a further pop-up window defining a console 235 may be opened. The console 235 may list the context information retrieved for each specific selected resource. The context information may be split between features and contacts in corresponding panels of a tabbed pane, for example. Particularly, the features may provide further data detailing the specific selected resource, while the contacts may identify information sources that may be addressed for retrieving additional information. In certain embodiments, the features for a non-compliant execution server may include its host name, site, and department. Contacts may include the owner of the non-compliant execution server and the support center of the corresponding non-compliant software product.

In some embodiments, the system administrator may select each desired contact in the console 235. As above, it may be possible to select a single contact (by double-clicking over it with the mouse), multiple contacts (by maintaining the CTRL key during contact selection) or all of them together (by double-clicking on a caption bar of the console 235). Alternatively, the contact may be selected automatically without any manual intervention, and possibly even without displaying the console 235.

In any case, a request for the selected contact may be automatically generated by adding the corresponding context information, or part thereof. For example, it may be possible to open a collaboration session in a corresponding window 240, with a new message for the selected contact that may be pre-filled with the context information. Once the system administrator has reviewed the request, s/he may submit it to the desired contact (i.e., by sending the message).

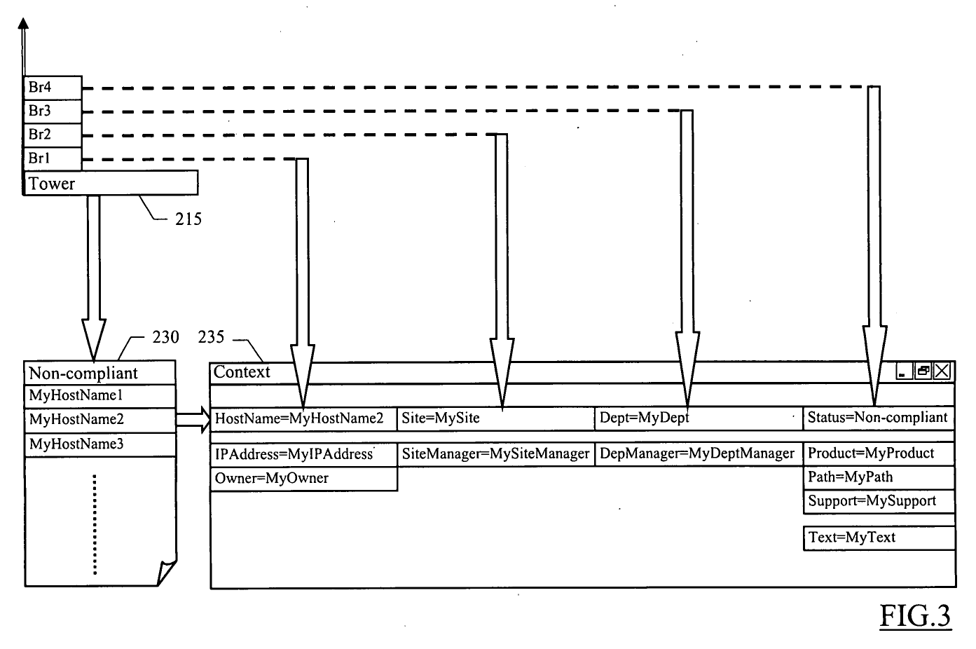

Referring now to FIG. 3, a brick Br1 may retrieve all the execution servers of a division by specifying in its retrieval instructions the selection of a host name in a corresponding database (“SELECT HostName”). A brick Br2 may filter the result according to a desired site (“MySite”) by specifying a corresponding condition (“WHERE Site=MySite”). A brick Br3 may further filter the result according to a desired department (“MyDept”) by specifying a corresponding condition (“WHERE Dept=MyDept”). Finally, a brick Br4 may restrict the result to the execution servers that are not compliant by specifying a procedure adapted to identify execution servers that are in a corresponding status (“Status=Non-compliant”). This procedure may involve discovering software products installed on all the resulting execution servers by invoking a discovery tool on each one of them. In the present example, software products installed on execution servers in the department “MyDept” at the site “MySite” may be discovered by invoking a discovery tool such has the IBM Tivoli Common Inventory Technology (“CIT”) by IBM Corporation.

This information collected on the runtime server may then be compared with the available licenses to identify execution servers that are not compliant. A non-compliance report in the viewer 230 may list the non-compliant execution servers by their host names (“MyHostName1,” “MyHostName2,” “MyHostName3,” and so on.)

Upon selecting a generic non-compliant execution server (such as “MyHostName2” in the present example), the corresponding context information may be retrieved in the console 235. For the sake of simplicity, the features and the contacts are not separately discussed. Each selected brick Br1-Br4 may be interrogated for its individual contribution to the context information by passing an identifier of the specific selected resource as a parameter (i.e., “MyHostName2”). In response, each selected brick Br1-Br4 may return the required information in the form of key/value pairs. Therefore, each basic block may be constructed to address specific aspects of the resources under management.

In a basic implementation, each selected brick Br1-Br4 may only provide an indication of the filtering criteria that it applied for the selection of the resources, taking into account the identifier received for the specific selected resource). In this example, the selected brick Br1 may return the pair “HostName=MyHostname2” since no filtering is applied. The bricks Br2, Br3 and Br4 may instead return the pairs “Site=MySite”, “Dept=MyDept” and “Status=Non-compliant,” respectively, for the filtering that they added during retrieval of the management information.

In addition or in the alternative, each selected brick Br1-Br4 may provide other data that is specifically retrieved for this purpose by exploiting the identifier of the specific selected resource. This data may be predefined, or it may be customized by the system administrator. For example, the selected brick Br1 may return an IP address of the non-compliant execution server (“IPAddress=MyIPAddress”), and a name of its owner (“Owner=MyOwner”). This data may be retrieved by executing a corresponding query on an inventory database storing information about all the execution servers of the division, with a condition based on the host name of the non-compliant execution server (“WHERE HostName=MyHostName2”).

Similarly, the selected brick Br2 and the selected brick Br3 may return a name of the manager of the site (“SiteManager=MySiteManager”) and a name of a manager of the department (“DeptManager=MyDeptManager”), respectively, of the non-compliant execution server. This result may be achieved by executing corresponding queries on a personnel database storing information about all the employees of the division, with conditions based on the filtering criteria applied by the selected brick Br2 (i.e., “WHERE Site=MySite”) and by the selected brick Br3 (i.e., “WHERE Dept=MyDept”).

The selected brick Br4 may return an identifier of the non-compliant software product (“Product=MyProduct”) and its installation path (“Path=MyPath”) by executing a query on a working table storing a result of the verification of compliance of the selected execution servers with a condition based on the host name of the non-compliant execution server (“WHERE HostName=MyHostName”). The selected brick Br4 may also return an indication of a support center for the non-compliant software product (“Support=MySupport”) by executing another query on a customer support database storing information about all the acquired software products with a condition based on the identifier of the non-compliant software product (“WHERE Product=MyProduct”).

In some embodiments, each selected brick may also provide fixed data that is independent of the specific selected resource. For example, the selected brick Br4 may return a predefined text (“Text=MyText”) for the message to be generated. The text may explain the problem and indicate the help that is requested, such as: “The following non-compliance event was detected: ______. We would be very grateful if you could explain the reasons for this discrepancy. Thank you very much for your kind cooperation.”

In certain embodiments, the message may be generated automatically in the session window, for example, with the text “MyText” followed by the data “HostName=MyHostname2”, “IPAddress=MyIPAddress”, “Owner=MyOwner”, “Site=MySite”, “SiteManager=MySiteManager”, “Dept=MyDept”, “DeptManager=MyDeptManager”, “Product=MyProduct”, “Path=MyPath”, and “Status=Non-compliant.”

This message may be sent to the owner of the non-compliant execution server. In one embodiment, for example, the message may be sent to the e-mail address indicated in the value “MyOwner.” Likewise, it may be possible to submit a similar message to the support center of the non-compliant software product by sending it, for example, to the e-mail address indicated in the value “MySupport.” In some cases, the content of the message may be reduced by filtering out non-relevant data, such as by only specifying the identifier of the non-compliant product (“Product=MyProduct”) and its installation path (Path=MyPath”).

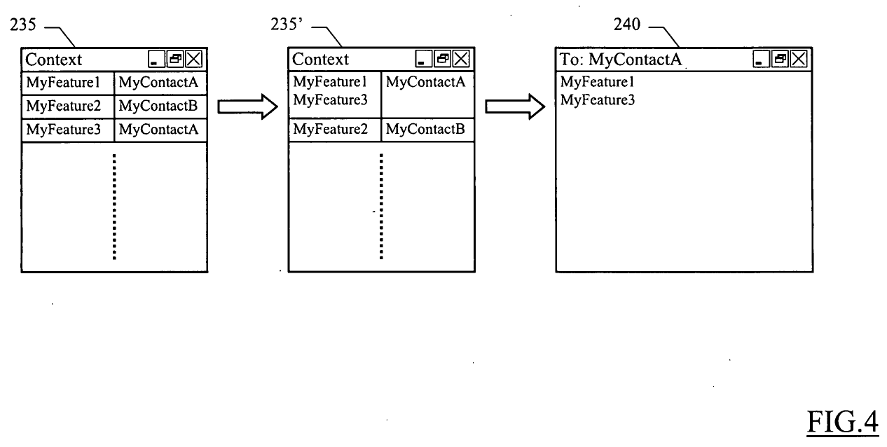

In an embodiment of the invention, as shown in FIG. 4, the context information of various selected resources may have some common values, such as for non-compliant execution servers that are under the responsibility of the same site manager or department manager, or for non-compliant execution servers having the same non-compliant software product installed.

In one example, the non-compliant execution server “MyHostName1” may be associated with the context information “MyFeature1” for the features, and “MyContactA” for the contacts. Likewise, the non-compliant execution servers “MyHostName2” and MyHostName3” may be associated with the context information “MyFeature2”-“MyContactB” and “MyFeature3”-“MyContactA”, respectively.

The context information may be aggregated for one or more specific common values. In this case, the records for the non-compliant execution servers “MyHostName1” and “MyHostName3” may be combined into a single record with the common field “MyContactA,” and an aggregated field formed by the concatenation of the corresponding fields “MyFeature1” and “MyFeature3,” as shown in a console differentiated with a prime notation, i.e., 235′. For the sake of simplicity, the features and the contacts of the context information are denoted with respective global fields in the console 235.

Therefore, it may be possible to generate a single request for multiple specific selected resources associated with a common record of the context information, such as for all the non-compliant execution servers assigned to the same site manager or department manager, or having the same non-compliant software product. In the above-described example, a message in the session window 240 may be generated for a selected contact indicated in the field “MyContactA”, with the data “MyFeature1” and “MyFeature3.” This may further facilitate retrieval of the additional information, especially in resource management systems controlling a high number of resources.

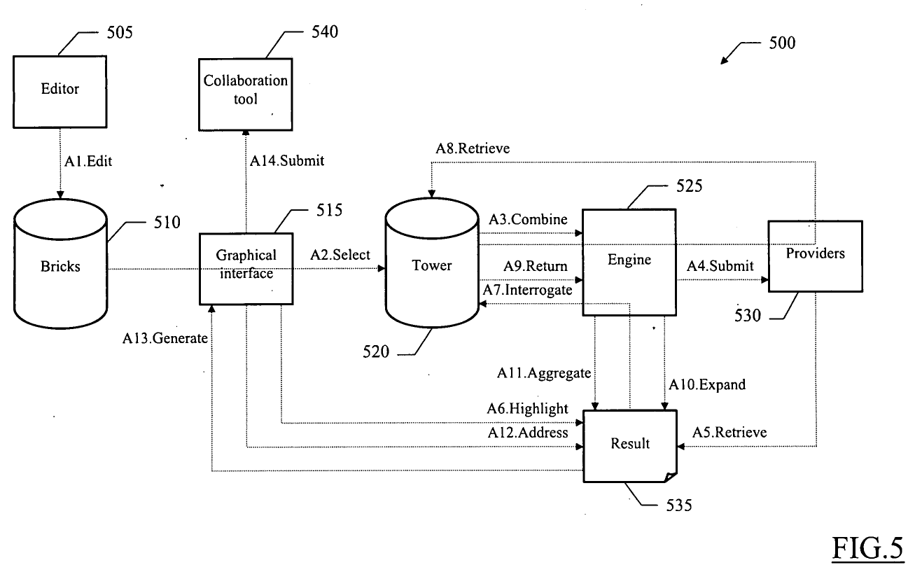

Referring now to FIG. 5, software components 500 may be used to implement embodiments of the invention. Information, such as programs and data, may be stored on the runtime server of a generic division and loaded at least partially into the working memory of the runtime server when the programs are running. An operating system and other application programs may also be included, although they are not shown in the figure. Programs may be initially installed onto the hard disk from a DVD-ROM, for example.

The figure illustrates the static structure of the system by means of the corresponding components. The figure further illustrates the dynamic behavior of the system by means of a series of exchanged messages. Each message represents a corresponding action, denoted with sequence numbers preceded by the symbol “A.”

In detail, an editor 505 may be used to create, update, delete, and perform any other edit operation on the basic blocks and the related bricks. A definition of the basic blocks and/or bricks may be stored in a corresponding repository 510 (action “A1.Edit”).

A graphical interface 515 may access this repository 510 to display the bricks in the palette. The system administrator may select a brick by dragging it to the tower. In response, an indication of the new brick may be added to a list of the selected bricks 520, after assigning the corresponding value to any parameter of its retrieval instructions (action “A2.Select”).

An engine 525 may access the list 520. Whenever the content of the tower changes (because a brick is either added or removed), a new retrieval statement may be generated by combining the retrieval instructions of the corresponding selected basic blocks (action “A3.Combine”). For this purpose, each basic block may expose an interface that may be invoked to combine it with other basic blocks. This may occur, for example, by adding a corresponding pre-canned fragment to a query, or by manipulating data of a generic domain into data of a generic co-domain for their consumption along the tower. The engine 525 may submit the retrieval statement to one or more providers 530, such as a DataBase Management System (“DBMS”), a discovery tool, or the like (action “A4.Submit”). The result of the retrieval statement (i.e., the management information for the selected resources) may be stored in a file 535 (action “A5.Retrieve”).

The system administrator may highlight, through the graphical interface 515, a specific selected resource of interest in the file 535 (action “A6.Highlight”). In response, the engine 525 may interrogate each selected basic block for the context information corresponding to the specific selected resource (action “A7.Interrogate”). Each basic block may also expose another interface, which may be invoked by passing the identifier of the specific selected resource. Each selected basic block may then process the interrogation.

When necessary, the selected basic block may retrieve further data through the engine 525 and the providers 530 (action “A8.Retrieve”). In any case, the required data, extracted directly from the retrieval instructions or specifically retrieved for this purpose, may be returned to the engine 525 (action “A9.Return”). The file 535 may be expanded accordingly with the context information returned by each selected basic block (action A10.Expand”). The system administrator may aggregate, through the graphical interface 515, the context information in the file 535 according to one or more common value. The engine 525 may then update the file 535 accordingly (action “A11.Aggregate”).

At this point, the system administrator may use the graphical interface 515 to select contacts extracted from the file 535 to address corresponding requests (action “A12.Address”). The request may then be generated according to the context information (action “A13.Generate”). The graphical interface 515 may submit this request to a collaboration tool 540, such as an instant messaging client or an e-mail client, for transmission to the selected contact (action “A14.Submit”).

Of course, one skilled in the art will recognize that embodiments of the invention may include many logical and/or physical modifications and alterations. More specifically, although embodiments of the present invention have been described with a certain degree of particularity with reference to the figures, it should be understood that various omissions, substitutions and changes in the form and details, as well as other embodiments, are possible. Embodiments of the invention may even be practiced without the specific details set forth in the preceding description. Conversely, well-known features may have been omitted or simplified in order not to obscure the description with unnecessary particulars. Moreover, it is expressly intended that specific elements and/or method steps described in connection with any disclosed embodiment of the invention may be incorporated in any other embodiment as a matter of general design choice.

Embodiments may be implemented with an equivalent method by using similar steps, removing some non-essential steps, or adding further optional steps. Moreover, one or more steps may be performed in a different order, concurrently, or in an interleaved way.

The same solution may be applied to other license management applications. For example, embodiments may be used to manage licensed software products such as video and/or audio contents, electronic books, and the like. Similar considerations apply to any information technology compliance domain, for example, with respect to security systems, or more generally to any resource management system such as for managing hardware devices, persons, company assets, or physical and/or logical resources.

Moreover, it should be readily apparent that the above-described management information, context information and additional information are merely illustrative and should not be interpreted as limiting in any way. Indeed, it is possible to retrieve the management information with equivalent retrieval statements (such as in the form of a query to be executed, a file to be read, a module to be run, a service to be invoked, and the like). Likewise, the request may include equivalent data (such as details about the license management process). The context information may also indicate which part thereof should be embedded in the request for each information source.

Similar considerations apply to various graphical interfaces provided for selecting the basic blocks. For example, it is possible to highlight any selected brick in the tower to obtain management information relating to a partial retrieval statement corresponding to the selected bricks up to the highlighted one, to drag more bricks to a same position along the tower (so as to combine them in logic OR), and the like. However, any specification (even in textual form) of the basic blocks is within the scope of the proposed solution. More generally, embodiments of the invention may be implemented as add-ons for a standard resource management system, where known techniques may be exploited for retrieving management information relating to the selected resources, for example.

Naturally, each basic block may return the corresponding context information in any other format, for example, in a table. Alternatively, it is also possible to retrieve the whole context information for each specific selected resource in a single operation rather than individually from each selected basic block. Retrieval of the context information from other providers is also contemplated herein.

In one embodiment of the invention, each basic block may be adapted to return, for the corresponding context information, only the indication of the filtering criteria, only the further data that is specifically retrieved for this purpose, only fixed data, or any combination thereof.

In another implementation, a request for the additional information may be automatically submitted to one or more predefined information sources for all the selected resources.

Reference to instant or e-mail messages is also merely illustrative. In addition or in alternative, requests may be submitted to the desired persons via SMS, VoIP, and the like. Requests may also be addressed to different persons, for example, a mentor, a subject-matter expert for a specific discipline or a specific software product, and the like. More generally, the requests may be submitted to a forum, a virtual-life environment, a self-teaching tool, an expert system, or any other information source.

The feature of aggregating the context information of multiple selected resources may also be implemented automatically without intervention by the system administrator. This feature, however, is not strictly necessary and may be omitted in some embodiments.

Embodiments of the invention may be implemented as stand-alone modules, plug-ins for the license management application, or even directly embedded in the license management application. It is also possible to deploy the same solution as a service accessed through a network such as the Internet. Similar considerations may apply if a program used to implement an embodiment of the invention is structured in a different way, or if additional modules or functions are provided. Likewise, memory structures may be of other types, or may be replaced with equivalent entities, not necessarily consisting of physical storage media). In any case, the program may take any form suitable to be used by any data processing system or in connection therewith, for example, within a virtual machine.

A computer program product in accordance with embodiments of the invention may be in the form of external or resident software, firmware, or microcode (either in object code or in source code—for example, to be compiled or interpreted). Moreover, it is possible to provide the program on any computer-usable medium. The medium may include any element suitable to contain, store, communicate, propagate, or transfer the program. For example, the medium may be of the electronic, magnetic, optical, electromagnetic, infrared, or semiconductor type. Examples of such medium types are fixed disks (where the program can be pre-loaded), removable disks, tapes, cards, wires, fibers, wireless connections, networks, broadcast waves, and the like. In any case, an embodiment of the present invention lends itself to be implemented with a hardware structure (for example, integrated in a chip of semiconductor material), or with a combination of software and hardware.

Further, a method in accordance with embodiments of the invention may be carried out on a system with a different architecture or including equivalent units. For example, the runtime servers and the administration server may be collapsed into a single control server for all the execution servers. It is also possible to have all the computers in the same location, for example, connected through a LAN. Each computer may have varying structures or may include similar elements, such as cache memories temporarily storing the programs or parts thereof. In any case, it may be possible to replace the computer with any code execution entity, such as a PDA, a mobile phone, and the like, or with a combination thereof, such as a multi-tier architecture, a grid computing infrastructure, and the like.

1. A method for managing resources in a resource management system, the method comprising:
providing a retrieval statement for retrieving management information relating to a set of selected resources;
retrieving the management information according to the retrieval statement;
retrieving context information relating to at least one resource of the set based on the management information;
generating a request for additional information relating to the at least one resource according to the context information; and
submitting the request for additional information to an information source.

2. The method of claim 1, wherein providing the retrieval statement further comprises:
providing a set of basic blocks, each block of the set including retrieval instructions for retrieving the management information;
selecting at least one block; and
combining the retrieval instructions for the at least one block into the retrieval statement.

3. The method of claim 2, wherein retrieving the context information further comprises interrogating the at least one block for a corresponding portion of the context information.

4. The method of claim 3, wherein the retrieval instructions comprise filtering criteria for selecting the resource.

5. The method of claim 3, wherein interrogating the block comprises receiving filtering criteria corresponding to the block.

6. The method of claim 3, wherein interrogating the block further comprises:
retrieving additional information relating to the at least one resource, the additional information differing from the management information; and
returning the additional information.

7. The method of claim 1, wherein the context information comprises a set of information sources.

8. The method of claim 7, wherein generating the request comprises addressing the request to at least one of the information sources.

9. The method of claim 8, wherein submitting the request comprises sending a message corresponding to the request to the at least one information source.

10. The method of claim 1, wherein the resource comprises a plurality of selected resources.

11. The method of claim 1, wherein retrieving the context information comprises aggregating the context information of the resources into aggregated context information.

12. The method of claim 11, wherein generating the request comprises generating at least one request for additional information regarding all the resources according to the aggregated context information.

13. A computer program product for managing resources in a resource management system, the computer program product comprising:
a computer-usable medium having computer-usable program code embodied therein, the computer-usable program code comprising:
computer-usable program code for providing a retrieval statement for retrieving management information relating to a set of selected resources;
computer-usable program code for retrieving the management information according to the retrieval statement;
computer-usable program code for retrieving context information relating to at least one resource of the set based on the management information;
computer-usable program code for generating a request for additional information relating to the at least one resource according to the context information; and
computer-usable program code for submitting the request for additional information to an information source.

14. A system for managing resources in a resource management system, the system comprising:
a repository storing management information relating to a set of selected resources;
a graphical user interface to display the management information;
an engine to retrieve the management information according to a retrieval statement, retrieve context information relating to at least one resource of the set based on the management information, and generate a request for additional information based on the context information; and
a collaboration tool to submit the request for additional information to an information source.
